(19) United States
(12) Patent Application Publication
(10) Pub. No.: US 2022/0362773 A1
(43) Pub. Date: Nov. 17, 2022

(54) DEVICES AND METHODS FOR HANDLING BIOLOGICAL SPECIMENS

(71) Applicant: STRATEOS, INC., Menlo Park, CA (US)

(72) Inventors: Christopher Rhodes, Oakland, CA (US); Gregory DeFoe, San Bruno, CA (US); Corey Monteith, San Francisco, CA (US); Joseph Springer, Mill Valley, CA (US); Kristy Parker, Denver, CO (US)

(21) Appl. No.: 17/739,424

(22) Filed: May 9, 2022

Related U.S. Application Data
(60) Provisional application No. 63/189,308, filed on May 17, 2021.

(51) Int. Cl. B01L 3/00

(52) U.S. Cl. CPC B01L 3/502761; B01L 2200/16; B01L 2300/069; B01L 2200/0652; B01L 2300/123

(57) ABSTRACT

Device and method for handling biological specimens. For example, the device includes a base and a substrate. The substrate includes a first surface disposed on the base and a second surface configured to support a biological specimen. A compressive element is disposed on the second surface of the substrate and surrounds the biological specimen. The compressive element includes an opening opposite the second surface of the substrate on which the compressive element is placed. The opening is configured to form a well that allows one or more reagents to be introduced into the well for chemically processing the biological specimen. The compressive element and the base cooperate to secure the compressive element to the substrate to form a seal which is configured to retain the one or more reagents in the well.

### CROSS-REFERENCE TO RELATED APPLICATIONS

This application claims priority to U.S. Provisional Patent Application No. 63/189,308, filed May 17, 2021, incorporated by reference herein for all purposes.

The following two applications, including this one, are being filed concurrently and the other application is hereby incorporated by reference in its entirety for all purposes:

1. U.S. patent application Ser. No. ______, titled “Devices and Methods for Handling Biological Specimens” (Attorney Docket Number 520295.000012); and

2. U.S. patent application Ser. No. ______, titled “Systems and Methods for Processing Biological Specimens” (Attorney Docket Number 520295.000013).

### FIELD OF THE DISCLOSURE

Some embodiments of the present disclosure are directed to handling biological specimens. More particularly, certain embodiments of the present disclosure provide devices and methods for capturing an array of biological specimens on a continuous substrate in an open-well format. Merely by way of example, the present disclosure has been applied to process the array of biological specimens to improve throughput. But it would be recognized that the present disclosure has much broader range of applicability.

### BACKGROUND OF THE DISCLOSURE

It is often desired to capture biological specimens for subsequent chemical processing. For example, the captured biological specimens may be stained for imaging purposes. Conventional methods utilize glass slides to capture and secure the biological specimens. However, the use of individual glass slides limits throughput. Accordingly, there exists a need to develop techniques that can better facilitate the handling of biological specimens.

### BRIEF SUMMARY OF THE DISCLOSURE

Some embodiments of the present disclosure are directed to handling biological specimens. More particularly, certain embodiments of the present disclosure provide devices and methods for capturing an array of biological specimens on a continuous substrate in an open-well format. Merely by way of example, the present disclosure has been applied to process the array of biological specimens to improve throughput. But it would be recognized that the present disclosure has much broader range of applicability.

According to certain embodiments, a device for handling biological specimens includes a base and a substrate. The substrate includes a first surface disposed on the base and a second surface configured to support a biological specimen. The device also includes a compressive element disposed on the second surface of the substrate and surrounding the biological specimen. The compressive element includes an opening opposite the second surface of the substrate on which the compressive element is placed. The opening is configured to form a well that allows one or more reagents to be introduced into the well for chemically processing the biological specimen. The compressive element and the base cooperate to secure the compressive element to the substrate to form a seal, which is configured to retain the one or more reagents in the well.

According to some embodiments, a device for handling biological specimens includes a base and a continuous substrate. The continuous substrate includes a first surface disposed on the base and a second surface configured to support a plurality of biological specimens. The device also includes a plurality of compressive elements disposed on the second surface of the continuous substrate, where each compressive element of the plurality of compressive elements surrounds a respective biological specimen. Each compressive element of the plurality of compressive elements includes an opening opposite the second surface of the continuous substrate on which each compressive element is placed. The opening is configured to form a well that allows one or more reagents to be introduced into the well for chemically processing the respective biological specimen. Each compressive element of the plurality of compressive elements cooperates with the base to secure each compressive element to the continuous substrate to form a respective seal, which is configured to retain the one or more reagents in the well.

According to certain embodiments, a method for handling biological specimens includes disposing a base on a first surface of a substrate. The substrate further includes a second surface. Also, the method includes disposing a biological specimen on the second surface of the substrate. Moreover, the method includes securing a compressive element on the second surface of the substrate that surrounds the biological specimen. The compressive element includes an opening opposite the second surface of the substrate on which the compressive element is placed. The opening is configured to form a well that allows one or more reagents to be introduced into the well for chemically processing the biological specimen. The compressive element and the base cooperate to secure the compressive element to the substrate to form a seal, which is configured to retain the one or more reagents in the well.

Depending upon the embodiment, one or more benefits may be achieved. These benefits and various additional objects, features and advantages of the present disclosure can be fully appreciated with reference to the detailed description and accompanying drawings that follow.

### BRIEF DESCRIPTION OF THE DRAWINGS

FIG. 1 shows a simplified device for handling a biological specimen according to certain embodiments of the present disclosure.

FIG. 2 shows a simplified device for handling a biological specimen according to some embodiments of the present disclosure.

FIG. 3 shows a simplified device for handling a plurality of biological specimens according to certain embodiments of the present disclosure.

FIG. 4 shows a simplified device for handling a plurality of biological specimens according to some embodiments of the present disclosure.

FIG. 5 shows a simplified method for handling biological specimens according to certain embodiments of the present disclosure.

### DETAILED DESCRIPTION OF THE DISCLOSURE

Some embodiments of the present disclosure are directed to handling biological specimens. More particularly, certain embodiments of the present disclosure provide devices and methods for capturing an array of biological specimens on a continuous substrate in an open-well format. Merely by way of example, the present disclosure has been applied to process the array of biological specimens to improve throughput. But it would be recognized that the present disclosure has much broader range of applicability.

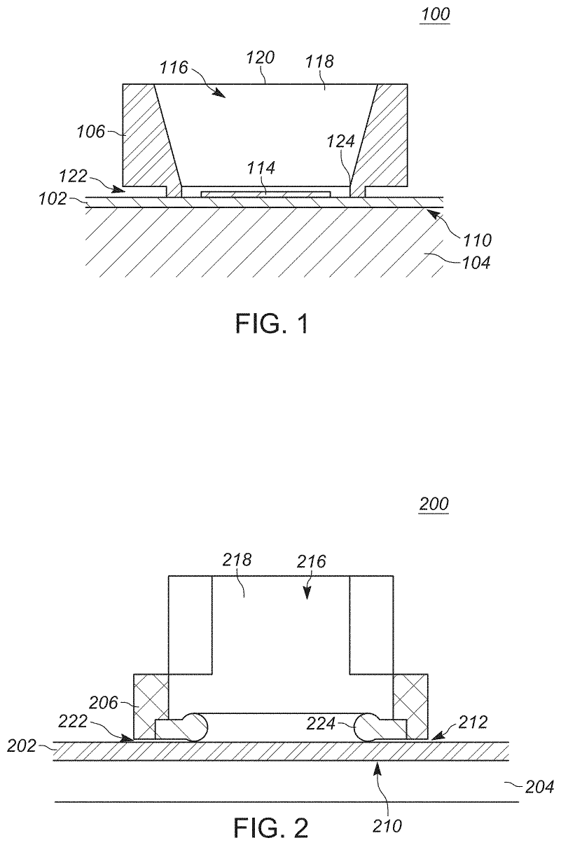

FIG. 1 shows a simplified device for handling a biological specimen according to certain embodiments of the present disclosure. This figure is merely an example, which should not unduly limit the scope of the claims. One of ordinary skill in the art would recognize many variations, alternatives, and modifications. The device 100 includes a substrate 102, a base 104, and a compressive element 106. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In various embodiments, the substrate 102 includes a first surface 110 and a second surface 112. For example, the first surface 110 is disposed on the base 104, and the second surface 112 is configured to support a biological specimen 114 (e.g., a tissue section, a blood sample, etc.).

In various embodiments, the substrate 102 is continuous. For example, the substrate 102 is formed by a continuous sheet. In some embodiments, the substrate 102 may be flexible, foldable, rollable, stretchable, etc. In certain embodiments, the substrate 102 may be rigid. In some embodiments, the substrate 102 includes an adhesive film such as a tape. For example, the second surface 112 of the substrate 102 includes the adhesive film that allows the biological specimen 114 to be attached to the second surface 112. In certain embodiments, the substrate 102 includes a non-adhesive film.

In some embodiments, the compressive element 106 is disposed on the second surface 112 of the substrate 102 to surround the biological specimen 114. In certain embodiments, the compressive element 106 includes an opening 116 opposite the second surface 112 of the substrate 102 on which the compressive element 106 is placed. For example, the opening 116 is configured to form a well 118. As an example, the well 118 is an open well that allows one or more reagents to be introduced into the well 118. In various embodiments, the well 118 is configured to receive a cover 120 to close the opening 116.

In certain embodiments, the compressive element 106 and the base 104 cooperate to secure the compressive element 106 to the substrate 102. For example, the base 104 includes a first magnetic material (e.g., a permanent magnet) and the compressive element 106 includes a second magnetic material (e.g., a metal). As an example, the second magnetic material of the compressive element 106 is magnetically attracted to the first magnetic material of the base 104 such that the compressive element 106 is secured on the substrate 102. For example, the magnetic attraction between the compressive element 106 and the base 104 allows the well 118 to be securely held in place. In some examples, other suitable means (e.g., pneumatic, mechanical, or hydraulic mechanism) can be used to create and secure the well 118 on the substrate 102. In certain examples, mechanisms that use neither magnetic nor pneumatic/hydraulic forces can be used to create and secure the well 118 on the substrate 102.

In some embodiments, contact between the compressive element 106 and the base 104 forms a seal 122. For example, once the well 118 is created, the one or more reagents can be introduced into the well 118 for chemically processing the biological specimen 114. As an example, the seal 122 is configured to retain the one or more reagents in the well 118. In certain embodiments, the seal 122 is formed by a section 124 of the compressive element 106 that is in direct contact with the second surface 112 of the substrate 102. For example, the section 124 of the compressive element 106 is a ring-shaped boss machined from stainless steel.

FIG. 2 shows a simplified device for handling a biological specimen according to some embodiments of the present disclosure. This figure is merely an example, which should not unduly limit the scope of the claims. One of ordinary skill in the art would recognize many variations, alternatives, and modifications. The device 200 includes a substrate 202, a base 204, and a compressive element 206. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In various embodiments, the substrate 202 includes a first surface 210 disposed on the base 204 and a second surface 212. In certain embodiments, the compressive element 206 is disposed on the second surface 212. In some embodiments, the compressive element 206 includes an opening 216 opposite the second surface 212. For example, the opening 216 is configured to form a well 218.

In some embodiments, the compressive element 206 and the base 204 cooperate to secure the compressive element 206 to the substrate 202 to form a seal 222. In certain embodiments, the seal 222 is formed by an elastomer element 224 (e.g., a washer, an O-ring, etc.) disposed between the compressive element 206 and the second surface 212 of the substrate 202.

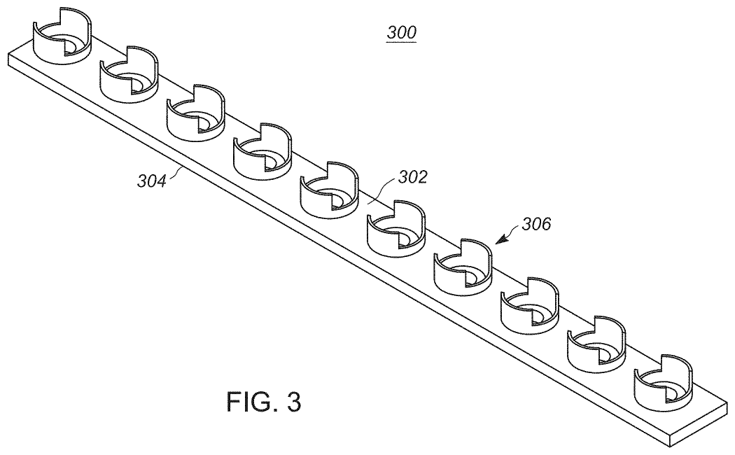

FIG. 3 shows a simplified device for handling a plurality of biological specimens according to certain embodiments of the present disclosure. This figure is merely an example, which should not unduly limit the scope of the claims. One of ordinary skill in the art would recognize many variations, alternatives, and modifications. The device 300 includes a continuous substrate 302, a base 304, and a plurality of compressive elements 306. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In certain embodiments, the plurality of compressive elements 306 are arranged along a single row. In certain embodiments, the plurality of compressive elements 306 and the base 304 cooperate to secure the plurality of compressive elements 306 on the continuous substrate 302.

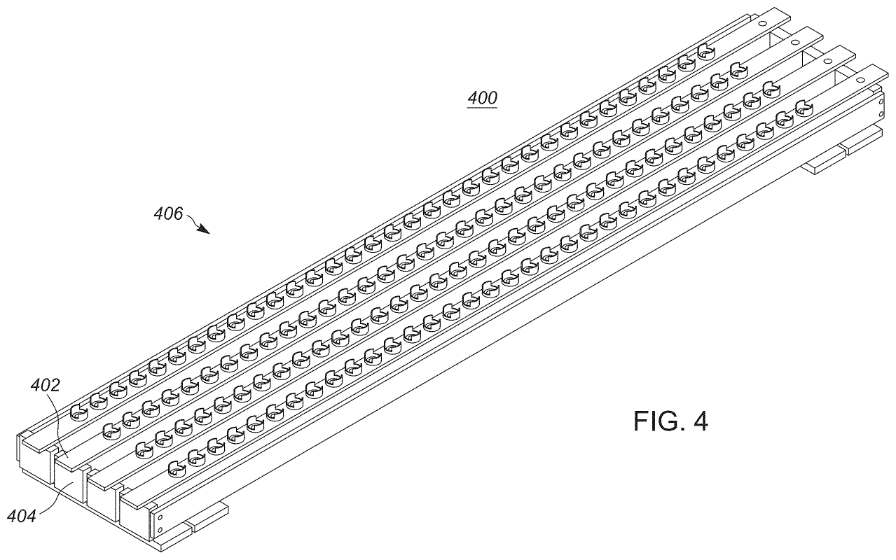

FIG. 4 shows a simplified device for handling a plurality of biological specimens according to some embodiments of the present disclosure. This figure is merely an example, which should not unduly limit the scope of the claims. One of ordinary skill in the art would recognize many variations, alternatives, and modifications. The device 400 includes a continuous substrate 402, a base 404, and a plurality of compressive elements 406. Although the above has been shown using a selected group of components for the system, there can be many alternatives, modifications, and variations. For example, some of the components may be expanded and/or combined. Other components may be inserted to those noted above. Depending upon the embodiment, the arrangement of components may be interchanged with others replaced.

In certain embodiments, the plurality of compressive elements 406 are arranged in multiple parallel rows. In certain embodiments, the plurality of compressive elements 406 and the base 404 cooperate to secure the plurality of compressive elements 406 on the continuous substrate 402.

In various embodiments, throughput improvements can be realized with a continuous substrate mounted with multiple wells. In certain embodiments, the multiple wells are configured as a liquid handling station in an addressable array such that each well assumes a known spatial position and is independently available for any chemical processing. In some embodiments, each well is positioned on the continuous substrate in a way that aligns the position of each well to a corresponding biological specimen. For example, N biological specimens are arranged in a row with the same center-to-center spacing D, and each well is positioned onto the continuous substrate with the same spacing. As an example, once N wells are aligned with N biological specimens, chemical processing can be performed in each well. For example, the wells are detached after chemical processing and the continuous substrate is mounted with another set of N biological specimens and N wells to repeat the procedure.

In certain embodiments, each biological specimen is identified virtually (e.g., its position known from prior information of its relative order on the substrate). In some embodiments, each biological specimen is identified physically (e.g., by printing or engraving an identification label such as alphanumeric characters, barcodes, etc.) on at least one layer of the continuous substrate. For example, the identification labels contain metadata such as an absolute position of the biological specimen on the continuous substrate, a relative position of the biological specimen on the continuous substrate to aid image registration, information on the origin of the biological specimen, instructions for the intended chemical process of the biological specimen, etc.

In some embodiments, by recording the address of a well each time that chemical processing is performed and by recording the spatial description of each biological specimen when loaded onto the continuous substrate, the relationship between each biological specimen and its sequence in the chemical processing can be retained for future use. For example, this relationship is recorded in electronic media (e.g., by inserting into a database during each step of a workflow). As an example, this relationship is useful when interpreting stained features of multichannel Z-stacks or in the correlation of specific transcript signals with spatial position in tissues.

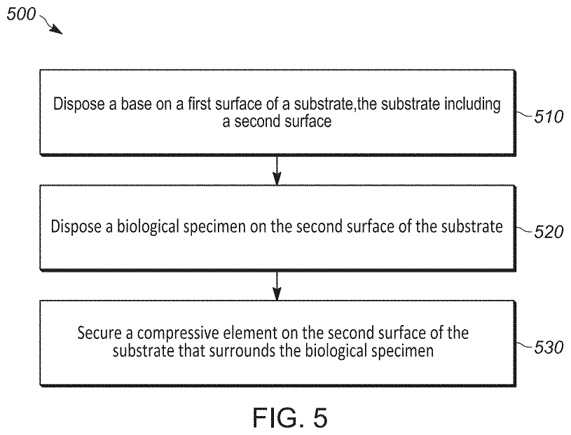

FIG. 5 shows a simplified method for handling biological specimens according to certain embodiments of the present disclosure. This figure is merely an example, which should not unduly limit the scope of the claims. One of ordinary skill in the art would recognize many variations, alternatives, and modifications. The method 500 includes process 510 for disposing a base, process 520 for disposing a biological specimen, and process 530 for securing a compressive element. Although the above has been shown using a selected group of processes for the method, there can be many alternatives, modifications, and variations. For example, some of the processes may be expanded and/or combined. Other processes may be inserted to those noted above. Depending upon the embodiment, the sequence of processes may be interchanged with others replaced. For example, some or all processes of the method are performed by a computing device or a processor directed by instructions stored in memory. As an example, some or all processes of the method are performed according to instructions stored in a non-transitory computer-readable medium.

At the process 510, the base is disposed on a first surface of a substrate according to certain embodiments. In some embodiments, the substrate includes a second surface. In certain embodiments, the substrate is formed by a continuous piece of tape that is flexible, foldable, rollable, stretchable, etc.

At the process 520, the biological specimen is disposed on the second surface of the substrate according to certain embodiments. In some embodiments, the second surface of the substrate includes an adhesive film that allows the biological specimen to be attached to the second surface.

At the process 530, the compressive element is secured on the second surface of the substrate that surrounds the biological specimen according to certain embodiments. In some embodiments, the compressive element includes an opening opposite the second surface of the substrate on which the compressive element is placed. For example, the opening is configured to form a well that allows one or more reagents to be introduced into the well for chemically processing the biological specimen.

In certain embodiments, the compressive element and the base cooperate to secure the compressive element to the substrate to form a seal which is configured to retain the one or more reagents in the well. In some examples, the seal is formed by a section of the compressive element in direct contact with the second surface of the substrate. In certain examples, the seal is formed by an elastomer element disposed between the compressive element and the second surface of the substrate.

According to certain embodiments, a device for handling biological specimens includes a base and a substrate. The substrate includes a first surface disposed on the base and a second surface configured to support a biological specimen. The device also includes a compressive element disposed on the second surface of the substrate and surrounding the biological specimen. The compressive element includes an opening opposite the second surface of the substrate on which the compressive element is placed. The opening is configured to form a well that allows one or more reagents to be introduced into the well for chemically processing the biological specimen. The compressive element and the base cooperate to secure the compressive element to the substrate to form a seal, which is configured to retain the one or more reagents in the well. For example, the device is implemented according to at least FIG. 1, FIG. 2, FIG. 3, and/or FIG. 4.

According to some embodiments, a device for handling biological specimens includes a base and a continuous substrate. The continuous substrate includes a first surface disposed on the base and a second surface configured to support a plurality of biological specimens. The device also includes a plurality of compressive elements disposed on the second surface of the continuous substrate, where each compressive element of the plurality of compressive elements surrounds a respective biological specimen. Each compressive element of the plurality of compressive elements includes an opening opposite the second surface of the continuous substrate on which each compressive element is placed. The opening is configured to form a well that allows one or more reagents to be introduced into the well for chemically processing the respective biological specimen. Each compressive element of the plurality of compressive elements cooperates with the base to secure each compressive element to the continuous substrate to form a respective seal, which is configured to retain the one or more reagents in the well. For example, the device is implemented according to at least FIG. 1, FIG. 2, FIG. 3, and/or FIG. 4.

According to certain embodiments, a method for handling biological specimens includes disposing a base on a first surface of a substrate. The substrate further includes a second surface. Also, the method includes disposing a biological specimen on the second surface of the substrate. Moreover, the method includes securing a compressive element on the second surface of the substrate that surrounds the biological specimen. The compressive element includes an opening opposite the second surface of the substrate on which the compressive element is placed. The opening is configured to form a well that allows one or more reagents to be introduced into the well for chemically processing the biological specimen. The compressive element and the base cooperate to secure the compressive element to the substrate to form a seal, which is configured to retain the one or more reagents in the well. For example, the method is implemented according to at least FIG. 5.

While the embodiments described above refer to particular features, the scope of the present disclosure also includes embodiments having different combinations of features and embodiments that do not include all of the described features. For example, various embodiments and/or examples of the present disclosure can be combined.

This specification contains many specifics for particular embodiments. Certain features that are described in this specification in the context of separate embodiments can also be implemented in combination in a single embodiment. Conversely, various features that are described in the context of a single embodiment can also be implemented in multiple embodiments separately or in any suitable subcombination. Moreover, although features may be described above as acting in certain combinations, one or more features from a combination can in some cases be removed from the combination, and a combination may, for example, be directed to a subcombination or variation of a subcombination.

Although specific embodiments of the present disclosure have been described, it will be understood by those of skill in the art that there are other embodiments that are equivalent to the described embodiments. Accordingly, it is to be understood that the present disclosure is not to be limited by the specific illustrated embodiments.

What is claimed is:

1. A device for handling biological specimens, the device comprising:
a base;
a substrate including a first surface disposed on the base and a second surface configured to support a biological specimen; and
a compressive element disposed on the second surface of the substrate and surrounding the biological specimen;
wherein:
the compressive element includes an opening opposite the second surface of the substrate on which the compressive element is placed; and
the opening is configured to form a well that allows one or more reagents to be introduced into the well for chemically processing the biological specimen;
wherein:
the compressive element and the base cooperate to secure the compressive element to the substrate to form a seal; and
the seal is configured to retain the one or more reagents in the well.

2. The device of claim 1, wherein the base includes a first magnetic material, and the compressive element is magnetically attracted to the first magnetic material to secure the compressive element on the substrate.

3. The device of claim 2, wherein the compressive element includes a second magnetic material.

4. The device of claim 2, wherein the compressive element includes a metal.

5. The device of claim 1, wherein the second surface of the substrate includes an adhesive film that allows the biological specimen to be attached to the second surface.

6. The device of claim 1, wherein the seal is formed by a section of the compressive element in direct contact with the second surface of the substrate.

7. The device of claim 1, wherein the seal is formed by an elastomer element disposed between the compressive element and the second surface of the substrate.

8. The device of claim 1, wherein the well is configured to receive a cover to close the opening.

9. The device of claim 1, wherein the substrate is formed by a continuous tape.

10. A device for handling biological specimens, the device comprising:
a base;
a continuous substrate including a first surface disposed on the base and a second surface configured to support a plurality of biological specimens; and
a plurality of compressive elements disposed on the second surface of the continuous substrate, each compressive element of the plurality of compressive elements surrounding a respective biological specimen;
wherein:
the each compressive element includes an opening opposite the second surface of the continuous substrate on which the each compressive element is placed; and
the opening is configured to form a well that allows one or more reagents to be introduced into the well for chemically processing the respective biological specimen; and
wherein:
the each compressive element cooperates with the base to secure the each compressive element to the continuous substrate to form a respective seal; and
the respective seal is configured to retain the one or more reagents in the well.

11. The device of claim 10, wherein the plurality of compressive elements are arranged in a single row.

12. The device of claim 10, wherein the plurality of compressive elements are arranged in multiple rows.

13. The device of claim 10, wherein the second surface of the continuous substrate includes an adhesive film that allows the plurality of biological specimens to be attached to the second surface.

14. The device of claim 10, wherein the respective seal is formed by a section of the each compressive element in direct contact with the second surface of the continuous substrate.

15. The device of claim 10, wherein the respective seal is formed by an elastomer element disposed between the each compressive element and the second surface of the continuous substrate.

16. A method for handling biological specimens, the method comprising:
disposing a base on a first surface of a substrate, the substrate further including a second surface;
disposing a biological specimen on the second surface of the substrate; and
securing a compressive element on the second surface of the substrate that surrounds the biological specimen;
wherein:
the compressive element includes an opening opposite the second surface of the substrate on which the compressive element is placed; and
the opening is configured to form a well that allows one or more reagents to be introduced into the well for chemically processing the biological specimen;
wherein:
the compressive element and the base cooperate to secure the compressive element to the substrate to form a seal; and
the seal is configured to retain the one or more reagents in the well.

17. The method of claim 16, wherein the second surface of the substrate includes an adhesive film that allows the biological specimen to be attached to the second surface.

18. The method of claim 16, wherein the seal is formed by a section of the compressive element in direct contact with the second surface of the substrate.

19. The method of claim 16, wherein the seal is formed by an elastomer element disposed between the compressive element and the second surface of the substrate.

20. The method of claim 16, wherein the substrate is formed by a continuous piece of tape.
